(19) United States
(12) Patent Application Publication
(10) Pub. No.: US 2006/0289174 A1
(43) Pub. Date: Dec. 28, 2006

(54) Deluge-like sprinkler fire scheme using high thermal sensitivity and high temperature rating sensing elements

(76) Inventor: Hong-Zeng Yu, Foxboro, MA (US)

Correspondence Address: MEREK, BLACKMON & VOORHEES, LLC, 673 S. WASHINGTON ST, ALEXANDRIA, VA, 22314, US

(21) Appl. No.: 11/370,904

(22) Filed: Mar. 9, 2006

Related U.S. Application Data
(60) Provisional application No. 60/692,577, filed on Jun. 22, 2005.

(51) Int. Cl. A62C 35/00

(52) U.S. Cl. 169/16; 169/37; 169/19; 239/209

(57) ABSTRACT

A fire protection sprinkler system has sprinklers whose thermal elements operate quickly, having high thermal sensitivity, specifically, RTI values of 40-100 (ft sec)^{1/2}, and a high temperature rating, in the range of 190° F.-650° F., preferably 212° F.-650° F., which temperatures are generally higher than the temperatures of a ceiling gas flow outside the designated area above a fire such that the combination of said Response Time Index value and said temperature rating prevents the sprinklers outside a designated area directly above the fire from actuating before extinguishant under said pressure is discharged from any of the sprinklers of the sprinkler system. The opening of a system valve upstream of all of the sprinklers of the system is synchronized with the actuation of the first sprinkler or sprinklers so that water is not discharged under full pressure from any actuated sprinklers until all of the sprinklers in the designated area are actuated, whereby sprinkler skipping is avoided.

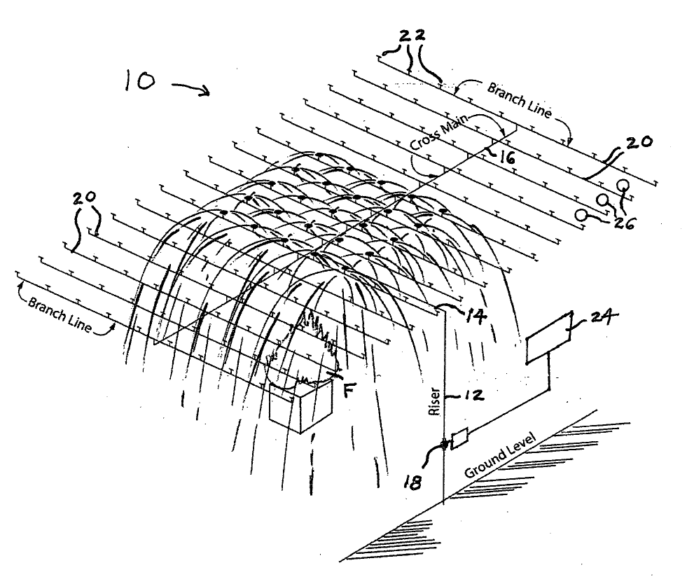

### CROSS-REFERENCE TO RELATED APPLICATION

The present application claims the benefit of U.S. Provisional Application No. 60/692,577, filed Jun. 22, 2005, which is incorporated herein in its entirety.

### BACKGROUND OF THE INVENTION

A typical sprinkler system is connected to a water supply (city supply, gravity tank or pump) and includes a system riser pipe that feeds cross main pipes, a system valve that is typically located in the riser pipe, cross main pipes that feed branch lines, branch lines, sprinklers mounted in the branch lines, and other accessories. In a conventional wet-pipe sprinkler system, water is discharged under pressure as soon as the first sprinkler directly above the fire is actuated, or first few sprinklers directly above the fire are actuated. Additional sprinklers will not be actuated until the fire grows further and overpowers the operating sprinkler or sprinklers.

Current dry-pipe and control-mode wet-pipe fire sprinkler protection systems use ceiling sprinklers equipped with thermal sensing elements, typically fusible links or glass bulbs, having high temperature ratings and low thermal sensitivity. The low thermal sensitivity means that the thermal sensing elements have high Response-Time-Index (RTI) values. Response-Time-Index indicates how fast the sprinkler can absorb, from its surroundings, heat sufficient to cause actuation.

As a result, the current dry-pipe systems and control-mode wet-pipe systems in general actuate relatively slowly and have to fight against fires that are already large when water begins to discharge from actuated sprinklers. As the fire challenge increases, more and more water droplets tend to be deflected by the fire plume back up to the ceiling level and carried in the ceiling gas flow, a layer of gas that flows generally horizontally at the ceiling. When water droplets are present in the ceiling gas flow, the droplets can impact, wet and cool the thermal sensing elements of sprinklers adjacent to the operating sprinklers and, thus, cause temporary or permanent delay of the actuation of these adjacent sprinklers, which are close to the fire, while sprinklers that are farther from the fire and have unwetted thermal sensing elements are actuated.

The aforementioned temporary or permanent delay of sprinkler actuations is known as sprinkler skipping. For conventional wet-pipe sprinkler systems consisting of ceiling sprinklers with thermal sensing elements, sprinkler skipping can be caused by one or more sprinklers discharging water as soon as they are actuated by the fire. As a result, the water spray coverage area varies with time and may consist of dry spots or low water-flux spots in the protected area. Consequently, the fire continues to spread, and the effectiveness of the sprinkler protection is severely reduced.

Full-scale fire tests have shown that, with the occurrence of sprinkler skipping, a fire can grow continuously and actuate sprinklers that are farther from the fire than are the skipped sprinklers, because the sprinklers farther from the fire are beyond the reach of the deflected water droplets in the ceiling gas flow but within the reach of the hot gases of the ceiling gas flow. These actuated remote sprinklers compete with sprinklers closer to the fire for a limited water supply but do not help suppress the fire.

### SUMMARY OF THE INVENTION

In fire protection sprinkler systems according to the present invention, water is not discharged from any sprinklers until all of the the sprinklers in a designated area above the fire are actuated. By “actuated” is meant that a sprinkler is opened, not necessarily that water or another extinguishant flows under pressure through the sprinkler. By “designated area” is meant the area directly above a fire, so that water discharged from the actuated sprinklers in the designated area covers the fire. In sprinkler systems according to the present invention, the sprinklers actuate progressively in all radial directions from the fire origin without skipping, because no water has been discharged at the time of actuation. Once all the sprinklers in the designated area above the fire are actuated, water is discharged simultaneously from all the actuated sprinklers. As a result, the fire is completely covered and surrounded by the sprinkler sprays, with no dry spots, and the effectiveness of the sprinkler system does not suffer due to sprinkler skipping. The present invention pre-empts sprinkler skipping by deluging the fire with closed-head type sprinklers, including conventional sprinklers and spray sprinklers. Of course, the sprinkler water discharge rate and pattern are chosen to be adequate to meet the fire challenge.

In “deluge” sprinkler systems, the sprinklers have no thermal sensing elements, such as fusible links or glass bulbs, but instead are always open to allow water to flow out freely from all of the sprinklers. A system valve that is opened by a fire detector is provided in “deluge” sprinkler systems upstream of all of the sprinklers. The present invention enables sprinklers having thermal sensing elements to produce a deluge of water through all of the sprinklers in the designated area all at once, thereby suppressing the fire, even though the thermal sensing elements keep the sprinklers closed until actuation. As a result, no or few additional sprinklers are needed to be actuated beyond the designated area. In order to minimize fire damage, which is related to fire size, and water damage, which is related to sprinkler coverage area, the deluge protection according to the present invention is implemented using sprinkler thermal sensing elements that have relatively high thermal sensitivity (low RTI value) and a high temperature rating. Requiring high thermal sensitivity and a high temperature rating is based on the fact that the quickness of sprinkler actuation is mainly controlled by the thermal sensitivity of the sensing elements and that the area in which the sprinklers can be actuated by a time after a fire starts is mainly determined by the temperature rating.

In order to cover the fire hazards in most industrial occupancies, the present invention overcomes the problem of sprinkler skipping by assuring that all of the sprinklers in the designated area actuate more quickly than in known systems and at the same time as one another. It does this by providing sprinklers whose thermal elements operate quickly, having RTI values of 40-100 (ft sec)^{1/2}, and whose temperature rating is high, in the range of 190° F. -650° F., preferably 212° F.-650° F. These temperatures are higher than the typical temperatures of the ceiling gas flow beyond the designated area. The temperature rating is such that the combination of the RTI value and the temperature rating prevents the sprinklers that are outside a designated area directly above the fire from actuating before extinguishant that is under the pressure of a source of the extinguishant is discharged from any of the sprinklers of the sprinkler system. There can be cases in which the temperature rating of sprinklers just outside the designated area are not higher than the temperatures of the ceiling gas flow in that area. Nevertheless, such sprinklers are not exposed to the ceiling gas flow for a long enough duration to actuate before extinguishant that is under the pressure of the source is discharged from one or more of the sprinklers that are inside the designated area.

Water does not flow out of any of the sprinklers of the present invention instantaneously. Instead, the RTI and the temperature rating are chosen such that the thermal elements of a group of sprinklers in the designated area actuate before water under pressure is discharged from any of the sprinklers. Nevertheless, the water in the system begins discharging under pressure from the actuated sprinklers faster than in conventional dry-pipe systems. In accordance with the present invention, the water delay time from the time the first sprinkler actuates, or first sprinklers actuate, to the time water under pressure discharges from the actuated sprinkler or sprinklers is made equal to or slightly greater than the actuation time interval from the first sprinkler actuation to the actuation of all of the sprinklers in the designated area.

Ideally, the water delay time is equal to the actuation time interval, but a water delay time less than the actuation time interval should be avoided, so that water can not discharge under pressure from the first actuated sprinkler or sprinklers and wet the thermal sensing elements of adjacent sprinklers before the adjacent sprinklers actuate. In view of this and in view of the limitations in providing a precise actuation time interval in a sprinkler system, systems according to the present invention are usually designed to make the water delay time slightly greater than the actuation time interval. Making the water delay time excessively greater than the actuation time interval has the risk of allowing the fire to grow unnecessesarily before water begins discharging under pressure. Since the pattern of ceiling gas flow induced by a fire plume is close to being axi-symmetrical, and since the arrangement of sprinklers in a sprinkler system is typically in square or rectangular pattern, the area in which sprinklers actuate tends to have a pattern of between circular and square or between circular and rectangular.

The time at which a sprinkler actuates after a fire starts depends on the sensitivity and the temperature rating of the thermal sensing element of the sprinkler, as well as the fire challenge, the radial distance of the sprinkler from the fire, and the vertical distance between the sprinkler and the ceiling of the protected area. Previous research has indicated that the sensitivity of a sprinkler thermal sensing element has a greater influence on the sprinkler actuation time than does its temperature rating. In addition, the temperature of the ceiling gas flow decreases exponentially from the fire. Therefore, in order to ensure that a) the fire does not grow too big before all the sprinklers in the designated area centered on the fire origin are actuated, which is mainly determined by sensitivity, and b) the designated area is just large enough to cover the fire area, which is mainly determined by the temperature rating, the present invention calls for sprinklers equipped with thermal sensing elements having a high thermal sensitivity and a temperature rating sufficiently high so that no sprinklers will be actuated beyond the designated area.

At a given location relative to the fire, the temperature of a sprinkler thermal sensing element is governed by fire growth history and the thermal responsiveness of the sensing element. The latter governing factor is determined by the heat exchange rate between the sprinkler sensing element and its surroundings through three different heat transfer modes: convection, conduction and radiation. The thermal response of the sprinkler sensing element is consequently a balance between the heat stored in the sensing element and the convective and radiative heat transferred to the sensing element and the conductive heat loss from the sprinkler sensing element to the sprinkler body. A mathematical expression of the heat balance may be written as

$$\frac{ⅆ ( Δ {T}_{ℓ} )}{ⅆ t} = \frac{u}{RTI} ( Δ T - Δ {T}_{ℓ} ) + \frac{{Q}_{R}}{{mC}_{ℓ}} - \frac{C}{RTI} Δ {T}_{ℓ} \qquad ( 1 )$$

in which the three terms on the right-hand side of the equation represent, respectively, heat convection, radiation and conduction. In Equation (1), ΔTₗ, represents the instantaneous excess sensing element temperature above ambient; u and ΔT denote the gas velocity and excess gas temperature in the vicinity of the sprinkler sensing element; RTI is the sprinkler sensitivity index, Q_{R} is the rate of radiative heat gain of the sensing element; m and Cₗ denote the mass and specific heat of the sensing element, and C is a conduction parameter for a sprinkler. The values of RTI and C are intrinsic properties of a sprinkler and are required to be quantified for sprinkler approval by accredited laboratories. Since the sprinkler sensing elements might not have a direct view of the fire due to shielding by piping and other objects, and since the fires are relatively small at actuation times for sprinklers equipped with high thermal sensitivity (low RTI values), the radiative heat transfer term in Equation (1) is negligible for the sprinkler response calculation for relatively remote sprinklers.

In accordance with the present invention, an RTI value for the sprinkler is chosen in the range of 40-100 (ft sec)^{1/2}. For a chosen RTI value, the appropriate temperature rating for the sprinkler can be determined by integrating Equation (1) and solving the integrated equation for the ΔTₗ values of the most remote sprinkler in the designated area and the nearest sprinkler just outside the designated area. A sprinkler temperature rating should be used such that the temperature rating is equal to or slightly higher than the sum of ambient temperature and ΔTₗ of the most remote sprinkler in the designated area, but is not higher than the sum of ambient temperature and ΔTₗ of the nearest sprinkler just outside the designated area. Such a temperature rating will be in the range 190° F. -650° F.

RTI and a conduction parameter C for a sprinkler are discussed in greater detail in Heskestad, G. and Bill, R G., Jr., “Modeling of Thermal Responsiveness of Automatic Sprinklers,” Proceedings of the Second International Symposium on Fire Safety Science, Hemisphere Publishing Corporation, 1989, pp. 603-612. Correlations of the temperature of the ceiling gas flow and velocity distributions in the fast fire growing period are given in Yu, H-Z and Stavrianidis, P., “The Transient Ceiling Flows of Growing Rack Storage Fires,” Proceedings of the 3rd International Symposium on Fire Safety Science, Elsevier Applied Science, 1991, pp. 281-290. Correlations of the temperature of the ceiling gas flow and velocity distributions in the slower fire growing period are given in Kung, H-C, Yu, H-Z and Spaulding, R D., “Ceiling Flows of Growing Rack Storage Fires,” Proceedings of Twenty-first Symposium on Combustion, The Combustion Institute, 1986, pp. 121-128.

The sprinkler fire protection scheme according to the present invention can be used to improve the fire protection performance of both current dry-pipe and control-mode wet-pipe sprinkler systems by preventing the occurrence of sprinkler skipping. In dry pipe systems using the present invention, as in conventional dry-pipe systems, the pipes downstream of the system valve are filled with air, nitrogen or other gases under pressure, the system valve being actuated when the gas pressure in the pipes falls due to a sprinkler opening. In order to speed up the response of the system valve, as low a gas pressure as possible is used in the pipes for system detection of the actuation of the first sprinkler or other fire detector, and the system valve is opened immediately at the start of gas pressure loss in the piping system, instead of being delayed until gas pressure drops to a designated level in accordance with the conventional practice. If necessary, exhausters, which are known in dry-pipe sprinkler systems, are installed to expedite venting of gas out of the sprinkler pipes. To further limit the fire size when water is discharged from the actuated sprinklers, other fire detectors, having a higher sensitivity or a lower tripping temperature than the sprinklers, can be deployed for fire detection in order to initiate the system valve opening process before any of the sprinklers is actuated. Typically, when used, a plurality of such other fire detectors are spaced from one another in a building. Such other fire detectors can be positioned at each sprinkler, or other numbers and/or positions can be used for such other fire detectors.

The differences between conventional dry-pipe systems and the present invention when applied to dry-pipe systems are:

1) Conventional dry-pipe systems call for low sprinkler sensitivity and high temperature rating. The present invention proposes high sensitivity and high temperature rating to limit fire size and water coverage area when water is discharged.

2) To reduce the water travel time from the system valve to actuated sprinklers, the gas pressure in the sprinkler piping (downstream of the system valve) is kept at a minimum, and the system valve is opened as soon as a drop in gas pressure is detected, instead of being opened when the differential pressure across the clapper of the system valve reaches a predetermined value.

3) The present invention is based on the research result that, to prevent additional sprinklers from being actuated after water is discharged, the water delay time after the first sprinkler actuation, or other fire detector actuation, has to be greater than or equal to the actuation time interval after the first sprinkler actuation by which all the sprinklers in the designated area are actuated.

In control-mode wet pipe systems, the discharge spray pattern contains water droplets that absorb the heat from the fire and a cool-down effect is given to the surrounding areas and roof. The fire plume tends to persist for a considerably long duration after the first sprinkler operation or operations, and sprinklers in a large area are required to operate to reduce the fire intensity, pre-wet combustibles and prevent the spread of the fire. Control mode is in contrast to suppression mode, in which the fire plume is intended to be penetrated by a heavy water discharge having high momentum, and in which a sufficient water discharge in an early phase of the fire can suppress a fire before a severe fire plume develops. In control-mode wet pipe systems using the present invention, the sprinkler pipes are filled with non-pressurized water instead of air or other inert gases in order to reduce, compared to a dry pipe system, the water delay time after the opening of the sprinkler system. The water is not discharged under system pressure (only drained) until all the sprinklers in the designated area are actuated.

The system valve, which is positioned upstream of all of the sprinklers in the system, is timed to open after or shortly before all of the sprinklers exposed to the fire have actuated, so that sprinklers discharge at the designated operating pressure shortly after all the sprinklers in the designated area are actuated. In dry pipe systems to which the present invention is applied, since there is a much longer delay from the opening of the system valve to the issuance of water under pressure from sprinklers, the system valve can be timed to open after the fire is detected but long before all of the sprinklers in the designated area have actuated, as long as water under pressure does not issue from any of the sprinklers until all of the sprinklers in the designated area have actuated. Whether the present invention is applied to dry pipe systems or control-mode wet pipe systems, there are a number of ways in which the system valve can be actuated in response to the sprinkler head being actuated.

For both dry-pipe and wet-pipe applications, a smaller fire size at water application time is essential in reducing fire damage. With the protection scheme according to the present invention, the fire size at the time that the water is first applied to the fire is reduced by the increased sensitivity of heat-sensing elements (low RTl values) and the shortened water delay time for water under pressure to reach the actuated sprinklers after the system valve opens. Since sprinkler heat-sensing elements of high thermal sensitivity (low RTI values) are used, the sprinkler temperature rating has to be sufficiently high in order to have sprinklers actuated only in the designated sprinkler coverage area surrounding the fire.

In the application of the present invention to a dry pipe system, the maximum size for a sprinkler system associated with a system valve can be determined for a protection condition (i.e., fire growth characteristics, ceiling clearance, sprinkler spacing, water supply pressure, sprinkler orifice size, sensitivity and temperature rating) by reconciling the time for water under pressure to reach the sprinklers and the time required for activating all sprinklers in the designated coverage area before water discharge. It is desirable that the required number of system valves be kept as small as possible in protecting an occupancy in order to keep system cost low and reliability high. If situations arise such that an unreasonably small system size is required to ensure that the water delay time does not greatly exceed the time required for activating all sprinklers in the designated area, the water delay time after fire detection can be further reduced by deploying separate and more-sensitive or lower-tripping-temperature heat sensors or fire detectors to detect the fire sooner than the sprinklers themselves do in order to activate the system valve. As a result of deploying separate and more-sensitive heat sensors or fire detectors, a larger system size can be realized for each system valve. When applying this protection scheme to wet-pipe applications, the presence of unpressurized water rather than gas in the sprinkler pipes reduces the delay before actuated sprinklers discharge water at the designated operating pressure.

For freezer protection, the present invention can use anti-freeze as the unpressurized liquid in a wet-pipe system or simply use a dry-pipe system.

### BRIEF DESCRIPTION OF THE DRAWING

The drawing FIGURE is a schematic illustration of sprinkler system according to the present invention.

### DETAILED DESCRIPTION OF THE PREFERRED EMBODIMENTS

As can be seen from the drawing FIGURE a sprinkler system according to the present invention, which is designated generally by the reference numeral 10, is shown in operation controlling a fire. Although its environment is not illustrated, the sprinkler system 10 is typically installed in a building, such as a warehouse, having a ceiling beneath which a hot ceiling gas flows generally horizontally in the event of a fire. The sprinkler system 10 receives water from a water supply (city supply, gravity tank or pump) and includes a system riser pipe 12 feeding a main pipe 14 that in turn feeds cross main pipes 16, a system valve 18 that is typically located in the riser pipe, branch lines 20 fed by the cross main pipes, and sprinklers 22 mounted in the branch lines, as well as accessories. The sprinklers 22 are spaced from one another in an arrangement covering an area extending across at least the area of any fire that might occur.

Although the present application describes embodiments of the invention in which water is used, it is understood that the present invention can be used with other extinguishants. The water in branch lines of conventional wet-pipe systems is pressurized, but the water in the branch lines 20 of the system according to the present invention is only slightly pressurized or not pressurized when the present invention is applied to wet-pipe sprinkler systems. There are different ways to detect the actuations of the sprinklers 22 under the non-pressurized condition so that the opening of the system valve 18 can be timely initiated. One example follows for illustration. When the non-pressurized water is drained from the actuated sprinklers, a vacuum is induced inside the sprinkler piping. For a typical axisymmetrical sprinkler actuation pattern (circular pattern) under free-burn condition, three to five consecutive, parallel branch lines 20 are involved when all the sprinklers 22 in the designated area centered on the origin of the fire F are actuated. A signal can be sent to the system valve 18 via a central control panel 24 when the vacuum in the sprinkler system is detected by a vacuum detection sensor. The vacuum detection can be expedited if each branch line 20 is equipped with a vacuum detection sensor.

As can be appreciated from the drawing FIGURE, water is not discharged from any of the sprinklers 22 until all of the the sprinklers in the designated area above the fire F are actuated. Once all the sprinklers 22 in the designated area above the fire F are actuated, water is discharged simultaneously from all the actuated sprinklers. The sprinklers 22 that are in the designated area completely cover and surround the fire with sprays from the sprinklers, with no dry spots. As a result, the fire is completely covered and surrounded by the sprinkler sprays, with no dry spots, and the effectiveness of the sprinkler system does not suffer due to sprinkler skipping. Typically, due to the generally square or rectangular arrangement of sprinklers in a sprinkler system, and due to the axi-symmetrical pattern of the ceiling gas flow induced by a fire plume, a group of sprinklers generally in a pattern close to that of a square or rectangle actuates before water begins discharging under pressure.

In order to minimize fire damage, which is related to fire size, and water damage, which is related to sprinkler coverage area, deluge protection is implemented by the present invention by using with the sprinklers 22 thermal sensing elements that have relatively high thermal sensitivity (low RTI value) and a high temperature rating. The thermal elements operate quickly, having RTI values of 40-100 (ft sec)^{1/2} and high temperature ratings, in the range of 190° F. -650° F., preferably 212° F. -650° F. These temperature ratings are such that the combination of the RTI value and the temperature rating prevents the sprinklers that are outside a designated area directly above the fire from actuating before extinguishant that is under the pressure of a source of the extinguishant is discharged from any of the sprinklers of the sprinkler system. There can be cases in which the temperature rating of sprinklers just outside the designated area are not higher than the temperatures of the ceiling gas flow in that area. Nevertheless, such sprinklers are not exposed to the ceiling gas flow for a long enough duration to actuate before extinguishant that is under the pressure of the source is discharged from one or more of the sprinklers that are inside the designated area.

For a chosen RTI value, the appropriate temperature rating for the sprinkler can be determined by integrating Equation (1) presented earlier herein and solving the integrated equation for ΔTₗ for the most remote sprinkler in the designated area and ΔTₗ for the nearest sprinkler just outside the designated area. A sprinkler temperature rating should be used such that the temperature rating is equal to or slightly higher than the sum of ambient temperature and ΔTₗ of the most remote sprinkler in the designated area, but is not higher than the sum of ambient temperature and ΔTₗ of the nearest sprinkler just outside the designated area. Such a temperature rating will be in the range 190° F. -650° F.

In dry pipe systems using the present invention, as in conventional dry-pipe systems, the pipes downstream of the system valve 18 are filled with air, nitrogen or other gases under pressure, the system valve being actuated when the gas pressure in the pipes falls due to a sprinkler opening. In order to speed up the response of the system valve, as low a gas pressure as possible is used in the pipes for system detection of the actuation of the first sprinkler or other fire detector, and the system valve 18 is opened immediately at the start of gas pressure loss in the piping system, instead of being delayed until gas pressure drops to a designated level in accordance with the conventional practice. If necessary, exhausters, which are known in dry-pipe sprinkler systems, are installed to expedite venting of gas out of the sprinkler pipes.

To further limit the fire size when water is discharged from the actuated sprinklers, other fire detectors 26, of higher sensitivity or lower tripping temperature than the sensing elements of the sprinklers 22, can be deployed for fire detection and can be connected, for example, to send a signal to the central control panel 24 in order to initiate the system valve 18 opening before any of the sprinklers is actuated. Typically, a plurality of such other fire detectors 26, when used, are spaced from one another in a building. Such other fire detectors can be positioned at each sprinkler 22, or other numbers and/or positions can be used for such other fire detectors. Only a few fire detectors 26 are illustrated, it being understood that such fire detectors are typically spaced generally uniformly across the area of a space to be protected.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

1. A sprinkler system for protecting a space having a ceiling from a fire producing a hot ceiling gas flow that flows generally horizontally at the ceiling, comprising:
pipes for conducting to the fire an extinguishant from a source of extinguishant under pressure;
sprinklers mounted on the pipes for issuing extinguishant from the pipes to the fire, the sprinklers being actuatable from a closed position to an open position and having thermal sensing elements for actuating the sprinklers; and
a system valve positioned upstream of all of the sprinklers to control flow of the extinguishant under said pressure to the sprinklers,
wherein the sprinklers each have a Response Time Index value in the range of 40-100(ft sec)^{1/2} and a temperature rating such that the combination of said Response Time Index value and said temperature rating prevents the sprinklers outside a designated area directly above the fire from actuating before extinguishant under said pressure is discharged from any of the sprinklers of the sprinkler system.

2. The sprinkler system of claim 1, wherein the sprinklers are spaced from one another in an arrangement covering an area extending across at least the area of the fire.

3. The sprinkler system of claim 1, further comprising a system valve controller responsive to actuation of any of the sprinklers to open the system valve to initiate flow of the extinguishant under pressure to the sprinklers,
whereby a group of sprinklers effective in controlling the fire is actuated without sprinkler skipping.

4. The sprinkler system of claim 1, wherein the sprinklers have a temperature rating in the range of 190° F. -650° F.

5. The sprinkler system of claim 1, wherein the sprinklers have a temperature rating in the range of 212° F.-650° F.

6. The sprinkler system of claim 1, further comprising fire detectors, each having at least one of higher sensitivity and a lower tripping temperature than the sprinklers, for opening the system valve before any of the sprinklers is actuated.

7. A method for protecting a space from a fire comprising:
providing, in a sprinkler system connected to a source of an extinguishant under pressure, sprinklers that actuate from a closed condition to an open condition in response to operation of thermal sensing elements;
delaying discharge of the extinguishant under said pressure from any of the sprinklers until all of the sprinklers that are in a designated area above the fire are actuated from a closed condition to an open condition; and
discharging the extinguishant simultaneously from all of the actuated sprinklers.

8. The method of claim 7, wherein the step of delaying comprises preventing the extinguishant under said pressure from reaching any of the sprinklers before the actuation of any of the sprinklers from a closed condition to an open condition, the method further comprising causing extinguishant under said pressure to flow to the sprinklers in response to the actuation of any of the sprinklers from a closed condition to an open condition, whereby extinguishant under said pressure is discharged simultaneously from all of the actuated sprinklers without sprinkler skipping.

9. The method of claim 7, wherein the sprinklers that are in the designated area completely cover and surround the fire with sprays from sprinklers, with no dry spots.

10. The method of claim 7, wherein delaying discharge of extinguishant under said pressure comprises actuating the sprinklers from a closed condition to an open condition by thermal sensing elements associated with the sprinklers, the thermal sensing elements each having Response-Time-Index values of 40-100 (ft sec)^{1/2} and a temperature rating such that the combination of said Response Time Index value and said temperature rating prevents the sprinklers outside the designated area from actuating before extinguishant under said pressure is discharged from any of the sprinklers of the sprinkler system.

11. The method of claim 10, wherein the thermal sensing elements each have a temperature rating in the range of 190° F. -650° F.

12. The method of claim 10, wherein the thermal sensing elements each have a temperature rating in the range of 212° F.-650° F.

13. The method of claim 7, wherein delaying discharge of extinguishant under said pressure comprises maintaining closed a system valve positioned upstream of all of the sprinklers and opening the system valve at least as early as the actuation of any of the sprinklers, but sufficiently late that the extinguishant under said pressure reaches the sprinklers at least as late as the time of actuation of all of the sprinklers in the designated area.

14. The method of claim 7, wherein delaying discharge of the extinguishant under said pressure comprises providing the sprinklers with sensing elements each having a Response Time Index value of 40-100 (ft sec)^{1/2} and a temperature rating such that the combination of said Response Time Index value and said temperature rating prevents the sprinklers outside a designated area directly above the fire from actuating before extinguishant under said pressure is discharged from any of the sprinklers of the sprinkler system.

15. The method of claim 7, wherein a system valve is provided upstream of all of the sprinklers, gas is maintained under pressure in the sprinkler system between the system valve and the sprinklers, and delaying discharge of extinguishant under the pressure of the source of the extinguishant comprises maintaining the system valve closed and opening the system valve immediately at the start of gas pressure loss in the sprinkler system.

16. The method of claim 15, wherein the gas pressure between the system valve and the sprinklers is maintained at a minimum.

17. The method of claim 15, wherein the gas pressure loss is due to a sprinkler opening.

18. The method of claim 7, wherein the extinguishant from the source is under a first pressure, a system valve is provided upstream of all of the sprinklers, and extinguishant having no more than a pressure less than said first pressure is maintained in the sprinkler system between the system valve and the sprinklers to reduce the delay between the actuation of all of the sprinklers in the designated area and the discharge of extinguishant under said first pressure from the sprinklers.

19. A sprinkler system for protecting a space having a ceiling from a fire producing a hot ceiling gas flow that flows generally horizontally at the ceiling, wherein the ceiling gas flow has a temperature, comprising:
pipes for conducting to the fire an extinguishant from a source of the extinguishant under pressure;
sprinklers mounted on the pipes for issuing extinguishant from the pipes to the fire, the sprinklers having thermal sensing elements for actuating the sprinklers;
a system valve positioned upstream of all of the sprinklers to control flow of the extinguishant under said pressure to the sprinklers; and
means for delaying discharge of extinguishant under said pressure from any of the sprinklers until all of the sprinklers in a designated area above the fire are actuated from a closed condition to an open condition.

20. The sprinkler system of claim 18, wherein wherein the means for delaying comprises the sprinklers each having Response Time Index values of 40-100 (ft sec)^{1/2} and a temperature rating such that the combination of said Response Time Index value and said temperature rating prevents the sprinklers outside a designated area directly above the fire from actuating before extinguishant under said pressure is discharged from any of the sprinklers of the sprinkler system.

21. The sprinkler system of claim 20, wherein the sprinklers each have a temperature rating in the range of 212° F.-650° F.

22. The sprinkler system of claim 20, wherein the sprinklers each have a temperature rating in the range of 190° F. -650° F.
